(19) United States
(12) Patent Application Publication
(10) Pub. No.: US 2019/0184988 A1
(43) Pub. Date: Jun. 20, 2019

(54) LANE KEEPING AND FOLLOWING SYSTEM

(71) Applicant: Hua-chuang Automobile Information Technical Center Co., Ltd., New Taipei City (TW)

(72) Inventors: Kang Li, New Taipei City (TW); Lih-Wei Jeng, New Taipei City (TW); You-Peng Jhang, New Taipei City (TW); Yuan-Chun Chen, New Taipei City (TW); Po-Fu Wu, New Taipei City (TW)

(21) Appl. No.: 15/968,191

(22) Filed: May 1, 2018

(30) Foreign Application Priority Data
Dec. 18, 2017 (CN) 201711368885.0

(51) Int. Cl. B60W 30/12; G05D 1/02; G01C 21/36; G01C 21/30

(52) U.S. Cl. CPC B60W 30/12; G05D 1/0278; G01C 21/367; G05D 1/0231; G08G 1/167; G05D 1/027; G05D 1/0274; G01C 21/30; G01C 21/3602; G05D 1/0257

(57) ABSTRACT

A lane keeping and following system applied to a vehicle includes a global positioning device, a high-precision road map unit, and a following control device. The global positioning device is used for continuously generating and outputting global positioning information. The high-precision road map unit is used for storing a plurality of pieces of road information. Each piece of road information includes lane information. Each piece of lane information includes lane marking geometric information. The following control device is electrically connected to the global positioning device and the high-precision road map unit, and is used for receiving the global positioning information and matching the road information, to find the lane information currently corresponding to the global positioning information, and retrieving the lane marking geometric information included in the current lane information and controlling the vehicle to travel following the current lane marking geometric information.

### CROSS-REFERENCE TO RELATED APPLICATION

This non-provisional application claims priority under 35 U.S.C. § 119(a) to Patent Application No. 201711368885.0 filed in China, P.R.C. on Dec. 18, 2017, the entire contents of which are hereby incorporated by reference.

### BACKGROUND

### Technical Field

The present new invention relates to the field of automobiles, and in particular, to a lane keeping and following system.

### Related Art

An automatic driving system controls a vehicle in a control manner such as acceleration, deceleration, turning, or gear shifting according to global positioning information, road geometry information, and road surrounding conditions. Therefore, as the automatic driving automobile gradually develops from semi-automatic driving to full-automatic driving, higher requirements are imposed on the precision of positioning.

Currently, a commercial global position system (GPS) device is usually of a road level, and has an error of approximately 10 meters. During navigation in a common environment, not only the precision of the location decreases, but also loss of accuracy easily occurs on determining in scenarios of turning and going uphill and downhill. The error may result in loss of accuracy of control on an automatic driving vehicle, and the safety of passengers is engendered.

Currently, there are high-precision GPS devices of a street or lane level. However, the price of a high-precision GPS device may exceed the price of a vehicle, being inconsistent with the configuration costs. Moreover, the high-precision GPS devices may still be affected by the weather, or the topography such as a tunnel, resulting in malfunction or inaccuracy.

### SUMMARY

To resolve the problem in the prior art, a lane keeping and following system applied to a vehicle is provided herein. The lane keeping and following system includes a global positioning device, a high-precision road map unit, and a following control device. The global positioning device is disposed on the vehicle and used for continuously generating and outputting global positioning information. The high-precision road map unit is disposed on the vehicle and used for storing a plurality of pieces of road information, where each piece of road information includes lane information, and each piece of lane information includes geometry information of a lane line. The following control device is disposed on the vehicle and electrically connected to the global positioning device and the high-precision road map unit, and is used for continuously receiving the global positioning information and continuously matching the road information, to find the lane information currently corresponding to the global positioning information, and retrieving the geometry information of a lane line included in the currently corresponding lane information and controlling the vehicle to travel following the geometry information of a lane line.

By using the global positioning device and the high-precision road map unit, high-precision positioning can be implemented, so that the following control device can control the vehicle to travel following the currently corresponding geometry information of a lane line and correct the currently corresponding geometry information of a lane line at any time. In this way, the costs of a conventional high-precision GPS can be greatly reduced, incorrect positioning guidance is avoided, and the vehicle can be correctly and safely controlled to travel, thereby facilitating the development of automatic driving.

### BRIEF DESCRIPTION OF THE DRAWINGS

FIG. 1 is a schematic block diagram of a lane keeping and following system;

FIG. 2 is a schematic top view of a lane keeping and following system;

FIG. 3a is a schematic diagram of road information in a high-precision map unit;

FIG. 3b is a schematic diagram of correcting a traveling path of a vehicle by a following control device according to road information;

FIG. 3c is a schematic diagram of a lane following image generated by a visual tracker;

FIG. 4 is a schematic diagram of positioning a vehicle on a lane by a following control device;

FIG. 5 is a schematic block diagram of an inertial measurement unit in FIG. 1;

FIG. 6 is a schematic diagram of a vehicle control curve; and

FIG. 7 is a curve diagram of driving data according to an actual embodiment of vehicle automatic driving.

### DETAILED DESCRIPTION

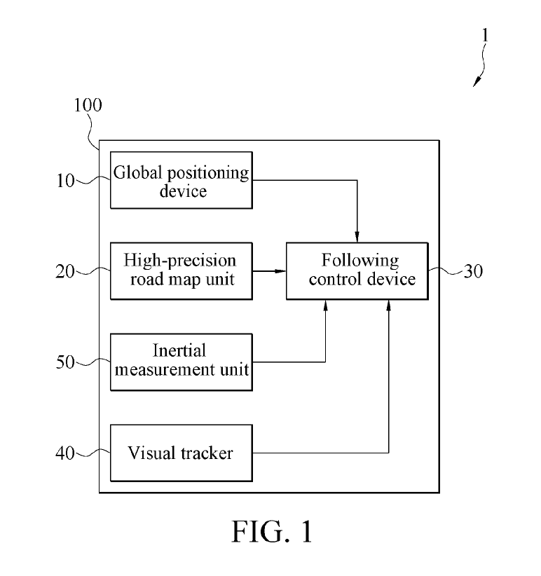

FIG. 1 is a schematic block diagram of a lane keeping and following system. As shown in FIG. 1, a lane keeping and following system 1 may be mounted on a vehicle 100. The lane keeping and following system 1 includes a global positioning device 10, a high-precision road map unit 20, and a following control device 30. The global positioning device 10, the high-precision road map unit 20, and the following control device 30 are all disposed on the vehicle 100. The global positioning device 10 is used for continuously generating and outputting global positioning information. The high-precision road map unit 20 is used for storing a plurality of pieces of road information. Each piece of road information includes at least one piece of lane information. Each piece of lane information includes geometry information of a lane line. The following control device 30 is electrically connected to the global positioning device 10 and the high-precision road map unit 20, and is used for continuously receiving the global positioning information and continuously matching the road information with the global positioning information, to find the lane information currently corresponding to the global positioning information. The following control device 30 is used for retrieving the geometry information of a lane line included in the piece of lane information and controlling the vehicle 100 to travel following the currently corresponding geometry information of a lane line.

The global positioning device 10 herein is a common GPS of a commercial road level, and an error of the global positioning information generated by the global positioning device 10 is about 10 meters. The road information of the high-precision road map unit 20 is of a street level or a lane level, and an error of the road information is less than 20 centimeters. The road information provided by the high-precision road map unit 20 may further include a road identifier, a road length, a lane quantity, a road speed limit, coordinates of a road starting point, coordinates of a road end point, coordinates of a stop line, and the like. The lane information may include a lane identifier, a lane width, and the like. Therefore, after receiving the global positioning information, the following control device 30 can match the global positioning information with the currently corresponding lane information and road information, determine a current location of the vehicle 100, and determine a road on which the vehicle 100 is located and a specific lane on the road, so that the following control device 30 controls the vehicle 100 to travel according to the geometry information of a lane line. The geometry information of a lane line may include coordinates of a starting point, coordinates of an end point, a curvature, and the like of the lane line.

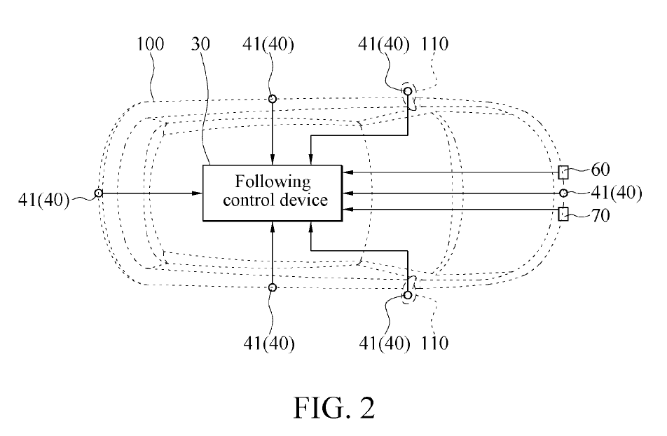

FIG. 2 is a schematic top view of a lane keeping and following system. As shown in FIG. 1 and FIG. 2, in some embodiments, the lane keeping and following system 1 further includes a visual tracker 40. The visual tracker 40 is electrically connected to the following control device 30, and is used for continuously retrieving and outputting a lane following image, and the following control device 30 is further used for correcting the currently corresponding geometry information of a lane line according to the lane following image, and controlling the vehicle 100 to travel following the corrected currently corresponding geometry information of a lane line. As shown in FIG. 2, the visual tracker 40 may be a lens 41 mounted at the front of the vehicle 100, and can continuously shoot the lane following image in front of the vehicle 100. In this way, the following control device 30 can perform correction according to an actual road image in addition to the global positioning information and the road information, making the positioning more precise.

In some other embodiments, the visual tracker 40 is used for continuously retrieving and outputting a surrounding image, the high-precision road map unit 20 is further used for storing at least one piece of location information of a point of interest, and the following control device 30 is further used for correcting the currently corresponding geometry information of a lane line with reference to the surrounding image and the location information of a point of interest, and controlling the vehicle 100 to travel following the corrected currently corresponding geometry information of a lane line. As shown in FIG. 2, the visual tracker 40 may be a lens 41 mounted on a side edge of the vehicle 100 or mounted on a back mirror 110 of the vehicle 100. The location information of a point of interest may be a traffic light location, a tourist attraction location, a building location, or a combination thereof. The following control device 30 herein further obtains a relative distance between the vehicle 100 and the point of interest by means of analysis according to the surrounding image and the location information of a point of interest, and re-determines the current lane information, so as to correct the currently corresponding geometry information of a lane line and control the vehicle 100 to travel following the currently corresponding geometry information of a lane line.

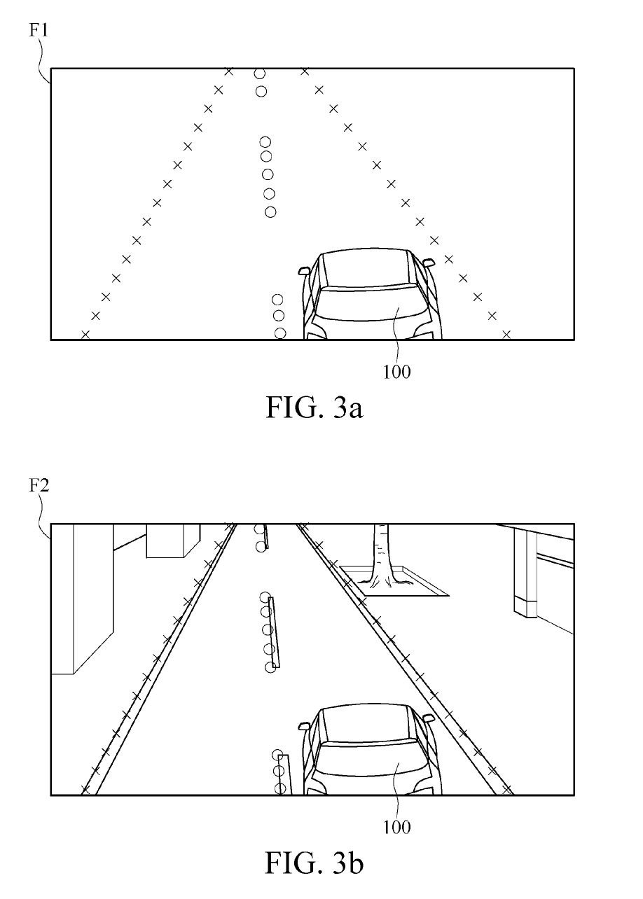

FIG. 3a is a schematic diagram of road information in a high-precision map unit. FIG. 3b is a schematic diagram of correcting a traveling path of a vehicle by a following control device according to road information. FIG. 3c is a schematic diagram of a lane following image generated by a visual tracker. A road information image F1 shown in FIG. 3a is a simulated image and shows geometry information of a lane line included in currently corresponding lane information. In combination with FIG. 1, the following control device 30 controls the vehicle 100 to travel following the currently corresponding geometry information of a lane line. As shown in FIG. 3b, correcting the traveling path of the vehicle 100 by the following control device 30 according to the road information is: using a superimposition image F2, which is a virtual image, to represent that the geometry information of a lane line included in the currently corresponding lane information is superimposed with the lane following image generated by the visual tracker 40, so as to perform correction according to a deviation between the lane following image and the geometry information of a lane line included in the currently corresponding lane information, thereby, as shown in FIG. 3c, keeping the geometry information of a lane line included in the lane information currently corresponding to the lane following image F3.

Further, existing automatic driving systems rely on the visual tracker 40 to perform road tracking. However, the visual tracker 40 may malfunction due to poor parsing in a specific scenario, such as a scenario with insufficient brightness or thick fog. That is, when the lane following image F3 in FIG. 3c disappears, the following control device 30 can still guide, by using the global positioning information provided by the global positioning device 10 and the road information provided by the high-precision road map unit 20, the vehicle to travel.

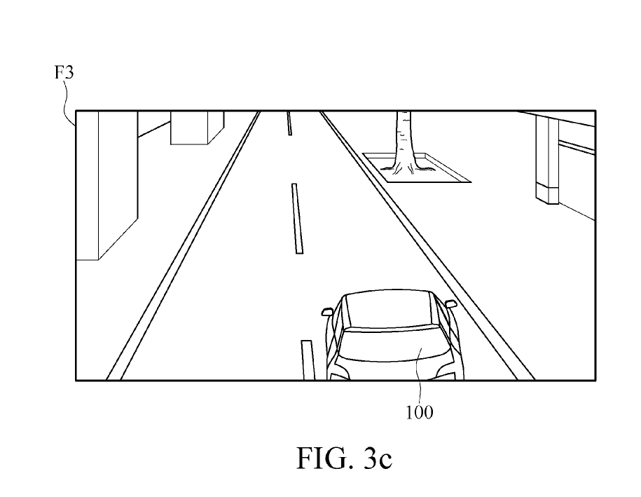

FIG. 4 is a schematic diagram of positioning a vehicle on a lane by a following control device. As shown in FIG. 1, FIG. 2, and FIG. 4, the following control device 30 can determine, by using the global positioning information provided by the global positioning device 10 and the road information provided by the high-precision road map unit 20, that the vehicle 100 is located on a lane D of a road R.

Further, referring again to FIG. 3a to FIG. 3c, the following control device 30 may alternatively use the lane following image F3 generated by the visual tracker 40 or a surrounding image (not shown) shot by another lens to assist in the positioning and correction, thereby keeping the vehicle 100 traveling on the lane D according to the currently corresponding geometry information of a lane line. This is merely an example herein, and the present invention is not limited thereto.

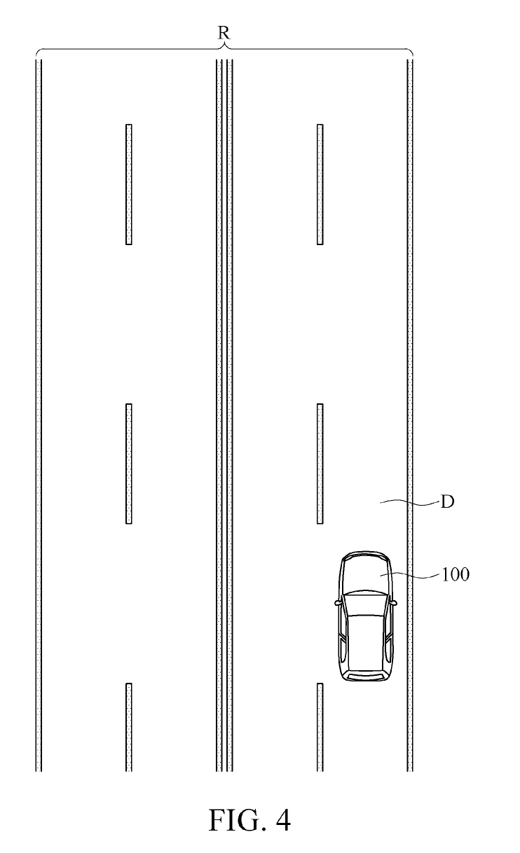

FIG. 5 is a schematic block diagram of an inertial measurement unit in FIG. 1. As shown in FIG. 1 and FIG. 5, in some embodiments, the lane keeping and following system 1 further includes an inertial measurement unit 50. The inertial measurement unit 50 is electrically connected to the following control device 30, and may include a gyroscope 53. The gyroscope 53 is used for continuously measuring and outputting a yawing angle and an angular velocity of the vehicle 100. The lane information further includes a road course angle. The following control device 30 is further used for controlling the vehicle 100 to travel following the currently corresponding geometry information of a lane line according to the yawing angle, the angular velocity, and the road course angle. In other words, the inertial measurement unit 50 measures a turning state of the vehicle 100, and performs determination based on the road information, so as to constantly track whether the geometry information of a lane line is consistent with the state of the vehicle 100, and constantly perform correction. In this way, a problem that a conventional GPS has a poor positioning effect on curved paths can be greatly improved.

Further, the inertial measurement unit 50 is used for continuously measuring and outputting a pitch angle and an acceleration. The lane information further includes a road slope. The following control device 30 is further used for controlling the vehicle 100 to travel following the currently corresponding geometry information of a lane line according to the pitch angle, the acceleration, and the road slope. Herein, as shown in FIG. 5, the inertial measurement unit 50 may include an accelerometer 51. In other words, the inertial measurement unit 50 continuously measures the pitch angle and the acceleration of the vehicle 100 to determine whether the vehicle 100 is in a state of going uphill or downhill, and further performs determination based on the road information, so as to track constantly whether the geometry information of a lane line is consistent with the state of the vehicle 100, and constantly perform correction. The foregoing method for measuring inertia of the vehicle 100 is merely an example, and the present invention is not limited thereto.

Referring again to FIG. 2 and FIG. 4, in some embodiments, the lane keeping and following system 1 further includes a radar detector 60. The radar detector 60 may be mounted on the vehicle 100, for example, mounted at the front of the vehicle 100. The radar detector 60 is electrically connected to the following control device 30. The radar detector 60 is used for continuously detecting and outputting a relative distance and a relative velocity of a nearby object. The following control device 30 is further used for controlling, with reference to the relative distance and the relative velocity of the nearby object, the vehicle 100 to travel following the currently corresponding geometry information of a lane line. The nearby object herein is an object, such as a vehicle, a pedestrian, or a traffic light on the lane D on which the vehicle 100 is located and on left and right lanes of the lane D.

In this way, the lane keeping and following system 1 controls the vehicle 100 to travel not only according to the road information, but also according to actual conditions surrounding the vehicle 100. For example, when the radar detector 60 detects that the vehicle 100 is too close to a vehicle ahead, the following control device 30 controls the vehicle 100 to slow down, to avoid collision. This is merely an example herein, and the present invention is not limited thereto.

Referring again to FIG. 2, in some embodiments, the lane keeping and following system 1 further includes a light sensor 70. The light sensor 70 is electrically connected to the following control device 30, and is used for continuously detecting and outputting a relative distance and a relative velocity of a light emitting object. The following control device 30 is further used for controlling, with reference to the relative distance and the relative velocity of the light emitting object, the vehicle 100 to travel following the currently corresponding geometry information of a lane line. In other words, the light sensor 70 may assist in determining under a condition of dim light, and can determine the relative distance and velocity according to light generated by the light emitting object, for example, a brake light of a vehicle ahead. In this way, the vehicle 100 can be controlled to travel according to actual conditions surrounding the vehicle 100. This is merely an example herein, and the present invention is not limited thereto.

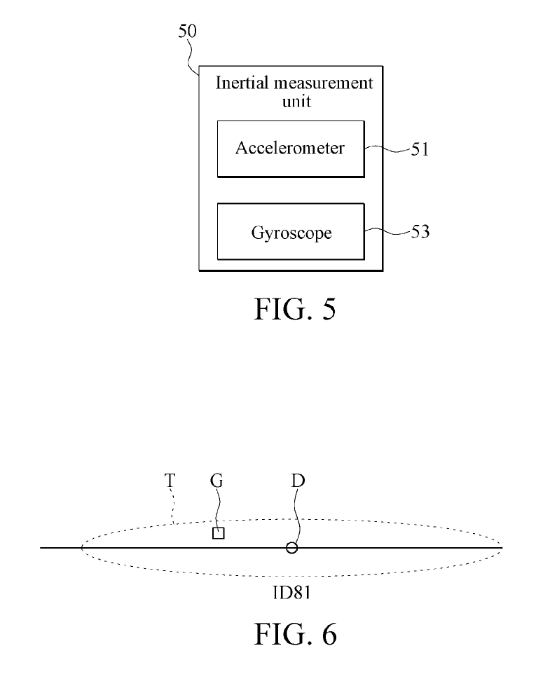

FIG. 6 is a schematic diagram of a vehicle control curve. Referring to FIG. 1, FIG. 4, and FIG. 6, the global positioning device 10 can provide a GPS original location G, and the following control device 30 receives the global positioning information G, and matches the road information provided by the high-precision road map unit 20 and the lane information in the road information, so as to determine that the vehicle 100 is located on the specific lane D of the road R, for example, an ID81 lane. In addition, the following control device 30 sets a deviation threshold T, and when a deviation of the vehicle 100 exceeds the deviation threshold T, the following control device 30 corrects the vehicle 100, to keep the vehicle 100 traveling on the specific lane D.

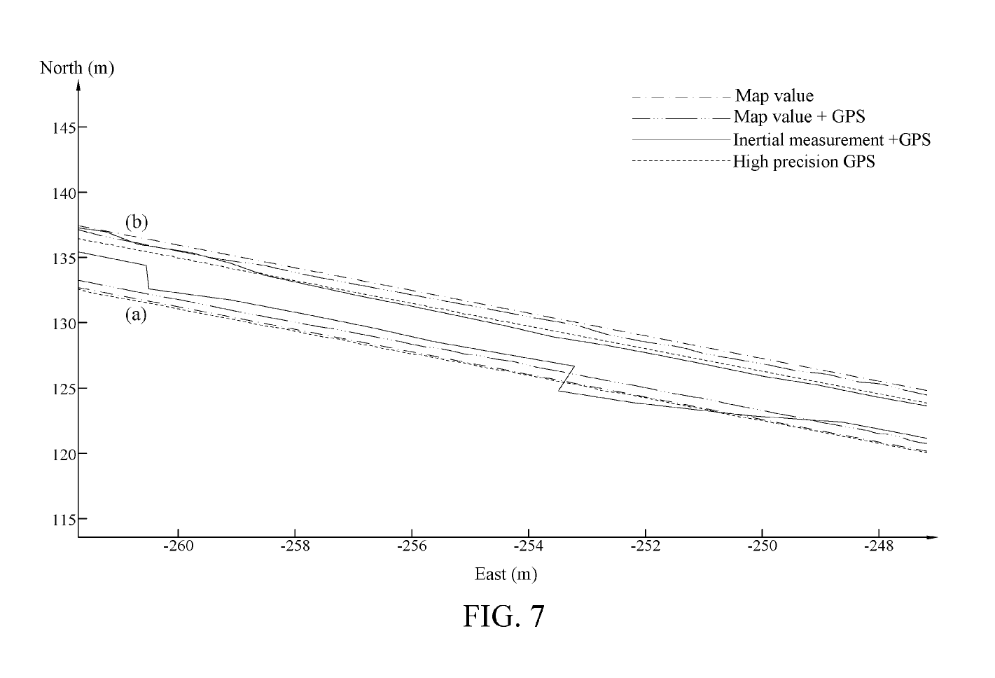

FIG. 7 is a curve diagram of driving data according to an actual embodiment of vehicle automatic driving. FIG. 7(a) and FIG. 7(b) are curve diagrams of driving data of driving on different paths. Driving paths of FIG. 7(a) and FIG. 7(b) each include four lines. A one-dot chain line represents a driving location connection line of a high-precision road map. A three-dot chain line is a driving location connection line of a commercial GPS (PM 220) in coordination with a high-precision road map unit. A dashed line is a driving location connection line of a high-precision GPS device (MB 2000). A solid line is a driving location connection line of a commercial GPS (PM 220) in coordination with an inertial measurement unit (SBG).

As shown in FIG. 7(a) and FIG. 7(b), a deviation between the driving location of the GPS in coordination with the inertial measurement unit and the driving location of the high-precision road map is relatively large, and a deviation between the driving location connection line of the commercial GPS (PM 220) in coordination with the high-precision road map unit or the high-precision GPS device (MB 2000) and the driving location of the high-precision road map is relatively small. In FIG. 7(b), a driving path of the commercial GPS (PM 220) in coordination with the high-precision road map unit is even closer, than the driving location of the high-precision GPS device (MB 2000), to the driving location of the high-precision road map. Therefore, in this application, correction by using the global positioning device in coordination with the high-precision road map unit by means of a pursuit algorithm actually can achieve an effect similar to that can be achieved by correction by using the high-precision GPS device, and has lower costs over the correction by using the high-precision GPS device.

By using the global positioning device and the high-precision road map unit, high-precision positioning can be implemented, so that the following control device can control the vehicle to travel following the currently corresponding geometry information of a lane line and correct the currently corresponding geometry information of a lane line. In this way, the costs can be greatly reduced, incorrect positioning guidance is avoided, and the vehicle can be correctly and safely controlled to travel.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A lane keeping and following system applied to a vehicle, the lane keeping and following system comprising:
a global positioning device disposed on the vehicle for continuously generating and outputting global positioning information;
a high-precision road map unit disposed on the vehicle for storing a plurality of pieces of road information, wherein each piece of road information comprises at least one piece of lane information, and each piece of lane information comprises lane marking geometric information; and
a following control device disposed on the vehicle and electrically connected to the global positioning device and the high-precision road map unit, for continuously receiving the global positioning information, continuously matching the pieces of lane information with the global positioning information to find a piece of lane information currently corresponding to the global positioning information, retrieving a currently corresponding lane making geometric information comprised in the piece of lane information, and controlling the vehicle to travel following the lane marking geometric information.

2. The lane keeping and following system according to claim 1, further comprising: a visual tracker disposed on the vehicle and electrically connected to the following control device, for continuously retrieving and outputting a lane following image, wherein the following control device is further used for correcting the currently corresponding lane marking geometric information according to the lane following image, and controlling the vehicle to travel following the corrected currently corresponding lane marking geometric information.

3. The lane keeping and following system according to claim 1, further comprising: a visual tracker disposed on the vehicle and electrically connected to the following control device, for continuously retrieving and outputting a surrounding image, wherein the high-precision road map unit is further used for storing at least one piece of location information of a point of interest, and the following control device is further used for correcting the currently corresponding lane marking geometric information according to the surrounding image and the location information of a point of interest, and controlling the vehicle to travel following the corrected currently corresponding lane marking geometric information.

4. The lane keeping and following system according to claim 3, wherein the location information of a point of interest is a traffic light location, a tourist attraction location, a building location, or a combination thereof.

5. The lane keeping and following system according to claim 1, further comprising: a radar detector, disposed on the vehicle and electrically connected to the following control device for continuously detecting and outputting a relative distance and a relative velocity of a nearby object, wherein the following control device is further used for controlling the vehicle to travel following the currently corresponding lane marking geometric information according to the relative distance and the relative velocity of the nearby object.

6. The lane keeping and following system according to claim 1, further comprising: a light sensor disposed on the vehicle and electrically connected to the following control device, for continuously detecting and outputting a relative distance and a relative velocity of a light emitting object, wherein the following control device is further used for controlling the vehicle to travel following the currently corresponding lane marking geometric information according to the relative distance and the relative velocity of the light emitting object.

7. The lane keeping and following system according to claim 1, further comprising: an inertial measurement unit disposed on the vehicle and electrically connected to the following control device, for continuously measuring and outputting a yawing angle and an angular velocity, wherein the piece of lane information further comprises a road heading angle, and the following control device is further used for controlling the vehicle to travel following the currently corresponding lane marking geometric information according to the yawing angle, the angular velocity, and the road heading angle.

8. The lane keeping and following system according to claim 1, further comprising: an inertial measurement unit disposed on the vehicle and electrically connected to the following control device, for continuously measuring and outputting a pitch angle and an acceleration, wherein the piece of lane information further comprises a road slope, and the following control device is further used for controlling the vehicle to travel following the currently corresponding lane marking geometric information according to the pitch angle, the acceleration, and the road slope.

9. The lane keeping and following system according to claim 1, wherein each piece of road information further comprises a road identifier, a road length, a lane quantity, a road speed limit, coordinates of a road starting point, coordinates of a road end point, coordinates of a stop line, or a combination thereof.

10. The lane keeping and following system according to claim 1, wherein each piece of lane information further comprises a lane identifier, a lane width, or a combination thereof.
